(19) United States
(12) Patent Application Publication
(10) Pub. No.: US 2026/0307040 A1
(43) Pub. Date: Oct. 8, 2026

(54) Layered Double Oxide and Preparation Method and Use Thereof

(71) Applicant: Quzhou Institute for Innovation in Resource Chemical Engineering, Quzhou City (CN)

(72) Inventors: Xianggui KONG, Quzhou City (CN); Meiqi ZHENG, Quzhou City (CN); Huanxu DU, Quzhou City (CN); Xue DUAN, Quzhou City (CN)

(21) Appl. No.: 19/337,867

(22) Filed: Sep. 23, 2025

(30) Foreign Application Priority Data
Apr. 3, 2025 (CN) 202510412286.2

(51) Int. Cl. B01J 20/04; B01J 20/02; B01J 20/28; B01J 20/30

(52) U.S. Cl. CPC B01J 20/041; B01J 20/0222; B01J 20/28059; B01J 20/28061; B01J 20/3021; B01J 20/3078; B01J 2220/4806

(57) ABSTRACT

Disclosed are a layered double oxide, a preparation method and use thereof. The preparation method of the layered double oxide includes: mixing magnesium oxide and a hydrate of a magnesium salt, and subjecting a resulting mixture to ball-milling to obtain a ball-milled material; mixing the ball-milled material and a hydrate of a manganese salt, and subjecting an obtained mixture to wet-milling to obtain a layered double oxide precursor; and subjecting the layered double oxide precursor to calcining to obtain the layered double oxide, where a molar ratio of magnesium in the magnesium oxide to magnesium in the magnesium salt is in a range of 1:1 to 6:1.

### CROSS REFERENCE TO RELATED APPLICATION

This patent application claims the benefit and priority of Chinese Patent Application No. 202510412286.2 filed with the China National Intellectual Property Administration on Apr. 3, 2025, the disclosure of which is incorporated by reference herein in its entirety as part of the present application.

### TECHNICAL FIELD

The present disclosure belongs to the technical field of adsorbent materials, and specifically relates to a layered double oxide, a preparation method and use thereof.

### BACKGROUND

Heavy metal ions in aqueous solutions exist either as cations or metal oxyanions. Cadmium is highly toxic. The excessive intake of cadmium might lead to cadmium poisoning, muscle atrophy, and joint deformity. Additionally, arsenic has been identified as a “known human carcinogen”. The long-term intake of drinking water with excessive arsenic can lead to chronic poisoning in the body. Compared with the cation form of Cadmium (Cd) that could be easily removed through adsorption or precipitation, the oxyanion form AsO₂⁻ exhibits high solubility and environmental mobility, and could migrate freely in the environment.

Currently, a variety of materials are used for the adsorption and immobilization of heavy metals in water/soil, such as metal-organic frameworks (MOFs), activated carbon, layered double hydroxides (LDHs), and iron-manganese oxides. Among them, LDHs are a class of clay compounds composed of host layers and interlayer anions. Due to unique two-dimensional layered structures, LDHs could remove heavy metals through various mechanisms such as interlayer anion exchange, memory effect, and isomorphous substitution. LDHs have demonstrated promising application prospects in the remediation of heavy metal-contaminated water.

However, the remediation of arsenic-cadmium co-contaminated systems poses severe difficulties, which remains a bottleneck in the control of heavy metal pollution. This is primarily attributed to the divergent impacts of pH and redox potential (Eh) on arsenic and cadmium: arsenic and cadmium are affected by pH and Eh in completely opposite ways. Arsenic tends to be stable under acidic conditions, whereas cadmium is stable under alkaline conditions. As a result, it is difficult to develop a suitable remediation agent capable of treating both arsenic and cadmium to mitigate the damage to human health. Currently, the preparation of materials for adsorbing heavy metals is faced with major problems. For example, the preparation of porous materials such as MOFs or covalent organic frameworks (COFs) requires complex processes, and relies primarily on expensive organic precursors, resulting in high material cost. Moreover, the preparation of these porous materials is easy to cause the generation of organic matter-containing wastewater, resulting in pollution. The common inorganic materials are prepared primarily through co-precipitation reactions or hydrothermal reactions of salts and alkalies. However, the corresponding preparation process leads to a large amount of saline wastewater. With the increasingly stringent environmental protection requirements, the discharge of saline wastewater has become a pressing issue to be solved. More importantly, the adsorbent materials currently developed have single adsorption sites. That is, these adsorbent materials could only selectively adsorb either cadmium or arsenic alone, and could hardly achieve the efficient adsorption for cadmium and arsenic simultaneously. Therefore, it is imperative to develop an adsorbent material that exhibits a multiple heavy metal-adsorbing effect and could be synthesized by an eco-friendly and convenient process.

### SUMMARY

An object of the present disclosure is to provide a layered double oxide, a preparation method and use thereof. The preparation method of the layered double oxide according to the present disclosure is simple. The layered double oxide prepared could synchronously remove arsenic and cadmium.

To achieve the above object, the present disclosure provides the following technical solutions:

The present disclosure provides a method for preparing a layered double oxide, including the following steps:
mixing magnesium oxide and a hydrate of a magnesium salt, and subjecting a resulting mixture to ball-milling to obtain a ball-milled material;
mixing the ball-milled material and a hydrate of a manganese salt, and subjecting an obtained mixture to wet-milling to obtain a layered double oxide precursor; and subjecting the layered double oxide precursor to calcining to obtain the layered double oxide,
where a molar ratio of magnesium in the magnesium oxide to magnesium in the magnesium salt is in a range of 1:1 to 6:1.

In some embodiments, the magnesium salt includes at least one selected from the group consisting of magnesium chloride, magnesium sulfate, magnesium carbonate, and magnesium nitrate.

In some embodiments, the manganese salt includes at least one selected from the group consisting of manganese chloride, manganese nitrate, manganese sulfate, and manganese carbonate.

In some embodiments, a molar ratio of manganese in the manganese salt to magnesium in the ball-milled material is in a range of 1:10 to 1:5.

In some embodiments, a ball-to-material ratio in the ball-milling and a ball-to-material ratio in the wet-milling are each independently 5:1 to 20:1; a rotational speed of the ball-milling and a rotational speed of the wet-milling are each independently 400 rpm to 800 rpm; milling balls adopted in the ball-milling and the wet-milling are made of zirconia; and the milling balls have a diameter independently of 1 mm to 10 mm.

In some embodiments, the calcining is conducted at a temperature of 300° C. to 500° C. for 2 h to 6 h.

In some embodiments, a heating rate of raising to the temperature for the calcining is in a range of 3° C./min to 10° C./min.

The present disclosure provides a layered double oxide prepared by the method as described in the above technical solutions, where the layered double oxide is a magnesium-manganese layered double oxide, and a molar ratio of manganese to magnesium in the magnesium-manganese layered double oxide is in a range of 1:10 to 1:5.

In some embodiments, the layered double oxide has a Brunauer-Emmett-Teller (BET) specific surface area of 50 m²/g to 200 m²/g.

The present disclosure provides use of a layered double oxide prepared by the method as described in the above technical solutions or the layered double oxide as described in the above technical solutions in simultaneous removal of arsenic and cadmium.

The present disclosure provides a method for preparing a layered double oxide, including the following steps: mixing magnesium oxide and a hydrate of a magnesium salt, and subjecting a resulting mixture to ball-milling to obtain a ball-milled material; mixing the ball-milled material and a hydrate of a manganese salt, and subjecting an obtained mixture to wet-milling to obtain a layered double oxide precursor; and subjecting the layered double oxide precursor to calcining to obtain the layered double oxide, where a molar ratio of magnesium in the magnesium oxide to magnesium in the magnesium salt is in a range of 1:1 to 6:1. During the synthesis process of the layered double oxide, when the magnesium oxide and the hydrate of the magnesium salt are mixed at the molar ratio of 1:1 to 6:1, the magnesium oxide could be activated based on the acidity characteristic of the magnesium salt, such that abundant active sites are generated on a surface of the magnesium oxide to create numerous magnesium defect sites. As a result, under the action of crystal water, the magnesium salt and the manganese salt could undergo a chemical reaction to produce a pure-phase composite metallic hydroxide. In this synthesis process, manganese ions would not be excessively oxidized into Mn⁴⁺, thereby avoiding the generation of oxide impurities (MnO₂) of manganese. In addition, during the reaction process, manganese ions are initially adsorbed onto the surface of magnesium oxide and react with free magnesium ions to produce a composite bimetallic hydroxide. The composite bimetallic hydroxide could then be readily converted into a layered double oxide through simple calcination. Compared with the conventional strong alkali such as sodium hydroxide or potassium hydroxide, magnesium oxide exhibits moderate alkalinity, which not only prevents the generation of oxide impurities of manganese, but also significantly reduces the alkali consumption. In addition, the use of mechanical grinding (ball-milling or wet-milling) eliminates the generation of wastewater, reduces the production cost, and alleviates the environmental pressure. In summary, the method according to the present disclosure is convenient and free of wastewater. According to the data from examples, the layered double oxide prepared according to the present disclosure exhibits excellent performance in the simultaneous remediation against cadmium and arsenic co-contamination. That is, the layered double oxide could treat both cadmium and arsenic. Therefore, the present disclosure provides an effective solution to the current challenge in simultaneously addressing cadmium and arsenic.

### BRIEF DESCRIPTION OF THE DRAWINGS

To describe the technical solutions in the embodiments of the present disclosure or in the prior art clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 shows an X-ray diffraction (XRD) pattern of the magnesium-manganese layered double oxide prepared in Example 1;

FIG. 2 shows a transmission electron microscopy (TEM) image of the magnesium-manganese layered double oxide prepared in Example 1;

FIG. 3 shows a BET plot of the magnesium-manganese layered double oxide prepared in Example 1;

FIG. 4 shows a kinetic curve of the adsorption of the magnesium-manganese layered double oxide to arsenic in Use Example 1;

FIG. 5 shows a comparison chart of adsorption capacities of the magnesium-manganese layered double oxide and other adsorbents to arsenic (As) in Use Example 2;

FIG. 6 shows a kinetic curve of the co-adsorption of the magnesium-manganese layered double oxide to arsenic and cadmium in Use Example 2; and

FIG. 7 shows an XRD pattern of the magnesium-manganese layered double oxide after adsorbing cadmium and arsenic in Use Example 2.

### DETAILED DESCRIPTION OF THE EMBODIMENTS

The present disclosure provides a method for preparing a layered double oxide, including the following steps:
mixing magnesium oxide and a hydrate of a magnesium salt, and subjecting a resulting mixture to ball-milling to obtain a ball-milled material;
mixing the ball-milled material and a hydrate of a manganese salt, and subjecting an obtained mixture to wet-milling to obtain a layered double oxide precursor; and
subjecting the layered double oxide precursor to calcining to obtain the layered double oxide,
where a molar ratio of magnesium in the magnesium oxide to magnesium in the magnesium salt is in a range of 1:1 to 6:1.

In some embodiments of the present disclosure, the magnesium salt includes at least one selected from the group consisting of magnesium chloride, magnesium sulfate, magnesium carbonate, and magnesium nitrate. In some embodiments of the present disclosure, the hydrate of the magnesium salt is specifically selected from the group consisting of magnesium chloride hexahydrate and magnesium nitrate hexahydrate. In some embodiments of the present disclosure, the magnesium oxide has an average particle size of 20 nm to 500 nm. In some embodiments of the present disclosure, the magnesium oxide having an average particle size of 50 nm is specifically adopted, for example. In some embodiments of the present disclosure, a molar ratio of the magnesium in the magnesium oxide to the magnesium in the magnesium salt is in a range of 1:1 to 6:1. In some embodiments, the molar ratio of the magnesium in the magnesium oxide to the magnesium in the magnesium salt is 1:1, 2:1, 3:1, 4:1, 5:1, or 6:1.

In some embodiments of the present disclosure, a ball-to-material ratio in the ball-milling is 5:1 to 20:1. In some embodiments, the ball-to-material ratio in the ball-milling is 5:1, 10:1, 15:1, or 20:1. In some embodiments, a rotational speed of the ball-milling is 400 rpm to 800 rpm. In some embodiments, the rotational speed of the ball-milling is 400 rpm, 500 rpm, 600 rpm, 700 rpm, or 800 rpm. In some embodiments, the ball-milling is conducted for 4 h to 6 h. In some embodiments, the ball-milling is conducted for 4 h, 5 h, or 6 h. Milling balls adopted in the ball-milling are made of zirconia. In some embodiments, the milling balls each have a diameter of 1 mm to 10 mm. In some embodiments, the milling balls each have a diameter of 1 mm, 5 mm, or 10 mm. In some embodiments of the present disclosure, among the zirconia balls, a mass proportion of the zirconia balls with a diameter of 1 mm is 15%, a mass proportion of the zirconia balls with a diameter of 5 mm is 25%, and a mass proportion of the zirconia balls with a diameter of 10 mm is 60%, for example. In the present disclosure, when the ball-milling is conducted under the above conditions, a large number of magnesium defects could be formed on the surface of magnesium oxide to enhance the chemical activity of magnesium oxide, making the magnesium oxide easily undergo a chemical reaction with manganese ions to produce a pure-phase composite metallic hydroxide.

In some embodiments of the present disclosure, after the ball-milled material is obtained, the ball-milled material and the hydrate of the manganese salt are mixed and then subjected to wet-milling to produce a layered double oxide precursor.

In some embodiments of the present disclosure, the manganese salt includes at least one selected from the group consisting of manganese chloride, manganese nitrate, manganese sulfate, and manganese carbonate. In some embodiments of the present disclosure, the hydrate of the manganese salt is specifically selected from the group consisting of manganese nitrate tetrahydrate and manganese chloride tetrahydrate, for example. In some embodiments of the present disclosure, a molar ratio of manganese in the manganese salt to magnesium in the ball-milled material is in a range of 1:10 to 1:5. In some embodiments, the molar ratio of manganese in the manganese salt to magnesium in the ball-milled material is 1:9, 1:8, 1:7, 1:6, or 1:5.

In some embodiments of the present disclosure, a ball-to-material ratio in the wet-milling is 5:1 to 20:1. In some embodiments, the ball-to-material ratio in the wet-milling is 5:1, 10:1, 15:1, or 20:1. In some embodiments, a medium for the wet-milling includes absolute ethanol. In some embodiments, a rotational speed of the wet-milling is 400 rpm to 800 rpm. In some embodiments, the rotational speed of the wet-milling is 400 rpm, 500 rpm, 600 rpm, 700 rpm, or 800 rpm. In some embodiments, the wet-milling is conducted for 3 h to 5 h. In some embodiments, the wet-milling is conducted for 3 h, 4 h, or 5 h. Milling balls adopted in the wet-milling are made of zirconia. The milling balls each have a diameter of 1 mm to 10 mm. In some embodiments, the milling balls each have a diameter of 1 mm, 5 mm, or 10 mm. In some embodiments of the present disclosure, among the zirconia balls, the mass proportion of the zirconia balls with a diameter of 1 mm is 15%, the mass proportion of the zirconia balls with a diameter of 5 mm is 25%, and the mass proportion of the zirconia balls with a diameter of 10 mm is 60%, for example. In some embodiments of the present disclosure, when the wet-milling is conducted under the above conditions, a large number of magnesium defects is further formed on the surface of magnesium oxide to enhance the chemical activity of magnesium oxide, making the magnesium oxide easily undergo a chemical reaction with manganese ions to produce a pure-phase composite metallic hydroxide.

In some embodiments of the present disclosure, after the wet-milling, the method further includes: subjecting a product obtained after the wet-milling to centrifugation, washing, and then drying to produce the layered double oxide precursor. In some embodiments, the washing is conducted with deionized water and ethanol successively. In some embodiments, the drying is conducted by oven-drying. In some embodiments, the oven-drying is conducted at a temperature of 40° C. to 90° C. In some embodiments, the oven-drying is conducted at 60° C.; the oven-drying is conducted for 6 h to 24 h. In some embodiments, the oven-drying is conducted for 12 h.

In the present disclosure, after the layered double oxide precursor is obtained, the layered double oxide precursor is subjected to calcining to produce the layered double oxide.

In some embodiments of the present disclosure, the calcining is conducted at a temperature of 300° C. to 500° C. In some embodiments, the calcining is conducted at 300° C., 400° C., or 500° C. In some embodiments, the calcining is conducted for 2 h to 6 h, specifically 2 h, 3 h, 4 h, 5 h, or 6 h. In some embodiments, a heating rate for raising the temperature for the calcining is in a range of 3° C./min to 10° C./min. In some embodiments, the heating rate is 5° C./min. In the present disclosure, when the calcining is conducted under the above conditions, the layered double oxide could be successfully prepared with low energy consumption. The temperature range specified for the calcining could prevent the generation of oxide impurities of manganese in the composite material. The above heating rate could effectively avoid the sintering phenomenon of a material (the sintering phenomenon could reduce a specific surface area of the material) caused by a too-high heating rate, and could also improve the preparation efficiency.

In some embodiments of the present disclosure, after the calcining, the method further includes cooling. In the present disclosure, there is no special limitations on a mode of the cooling, and the natural cooling may be adopted.

The present disclosure provides a layered double oxide prepared by the method as described in the above technical solutions. In some embodiments of the present disclosure, a molar ratio of manganese to magnesium in the magnesium-manganese layered double oxide is in a range of 1:10 to 1:5. In some embodiments, the molar ratio of manganese to magnesium in the magnesium-manganese layered double oxide is 1:5, 1:7, or 1:10.

In some embodiments of the present disclosure, the magnesium-manganese layered double oxide has a BET specific surface area of 50 m²/g to 200 m²/g. In some embodiments, the magnesium-manganese layered double oxide has the BET specific surface area of 185 m²/g.

The layered double oxide prepared according to the present disclosure has a larger specific surface area and more abundant active sites (including oxidation sites and adsorption sites) compared with a magnesium-manganese layered double hydroxide (MgMn-LDH), which is beneficial for treating the combined pollution of heavy metals arsenic and cadmium.

The present disclosure provides use of a layered double oxide prepared by the method as described in the above technical solutions in simultaneous removal of arsenic and cadmium in water. In the present disclosure, there is no specific limitations on a specific use method of the layered double oxide, and a use method well known to those skilled in the art may be adopted.

Due to high catalytic activity, the magnesium-manganese composite oxide obtained in the present disclosure could be hydroxylated through a hydration reaction with water molecules on the surface in an aqueous solution. During the hydroxylation, arsenite and arsenate ions are very prone to complexation with hydroxyl groups, which enables the adsorption of arsenite and arsenate ions to the magnesium-manganese composite oxide. Moreover, during the hydration process of the magnesium-manganese composite oxide, arsenic pollutants existing as anions could intercalate into the interlayer spaces, that is, the magnesium-manganese composite oxide could provide multiple pathways for arsenic removal. Thus, the magnesium-manganese composite oxide of the present disclosure demonstrates a much larger adsorption capacity for arsenic than the existing adsorbents. Magnesium and cadmium ions have relatively similar ionic radii and similar coordination numbers, and magnesium hydroxide has greater solubility than cadmium hydroxide. Therefore, cadmium ions are prone to a substitution reaction with active magnesium ions, that is, cadmium ions could enter lattices of the magnesium-manganese composite oxide. During the hydroxylation, a cadmium-containing composite hydroxide is produced. In this way, the simultaneous removal of cadmium and arsenic is achieved.

In summary, the magnesium-manganese composite oxide obtained in the present disclosure can achieve the arsenic removal through hydroxyl complexation and interlayer confinement and the cadmium removal through isomorphous substitution, and has a promising application prospect in the simultaneous removal of arsenic and cadmium in water.

In order to further illustrate the present disclosure, the technical solutions of the present disclosure are described in detail below in conjunction with accompanying drawings and examples, but these examples should not be understood as limiting the scope of the present disclosure.

### Example 1

1.21 g (0.03 mol) of nano-magnesium oxide (with a particle size of 50 nm) and 2.03 g (0.01 mol) of magnesium chloride hexahydrate were weighed and added to a 316 L stainless-steel ball-mill jar filled with zirconia balls in a total mass of 20 g. Among the zirconia balls, a mass proportion of the zirconia balls with a diameter of 1 mm was 15%, a mass proportion of the zirconia balls with a diameter of 5 mm was 25%, and a mass proportion of the zirconia balls with a diameter of 10 mm was 60%. A resulting mixture was subjected to ball-milling at a rotational speed of 600 rpm for 4 h. Then, the ball-mill jar was opened, 1.58 g (0.008 mol) of manganese chloride tetrahydrate was added to the opened ball-mill jar, 3 mL of absolute ethanol was added thereto and mixed evenly. An obtained mixture was further subjected to ball-milling at a rotational speed of 600 rpm for 6 h, and then centrifugation to obtain a precipitate. The precipitate was subjected to washing with deionized water and ethanol in sequence three times, and then drying in a 60° C. oven for 12 h to obtain a magnesium-manganese layered double oxide precursor (magnesium-manganese layered double hydroxide MgMn-LDH). A molar ratio of Mg²⁺ to Mn²⁺ in the magnesium-manganese layered double oxide precursor was 5:1. The magnesium-manganese layered double oxide precursor was placed in a muffle furnace, and heated to 350° C. at a heating rate of 5° C./min, calcined at 350° C. for 3 h, and then cooled naturally to obtain a magnesium-manganese layered double oxide (a molar ratio of manganese to magnesium in the magnesium-manganese layered double oxide was 1:5).

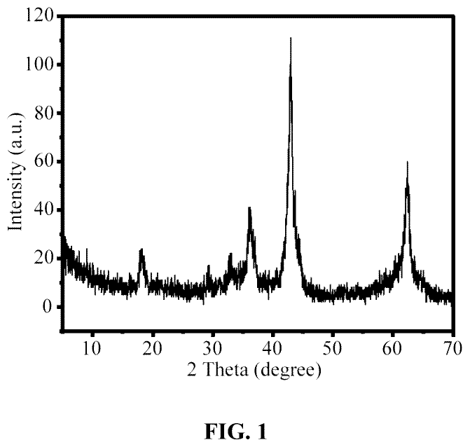

FIG. 1 shows an XRD pattern of the magnesium-manganese layered double oxide prepared in Example 1. It can be seen from FIG. 1 that, when the calcining temperature is 350° C., layered MgMn-LDO is produced (pattern information: 2θ=18.7°, 29.8°, 32.9°, 36.9°, 43.3°, and 62.8°).

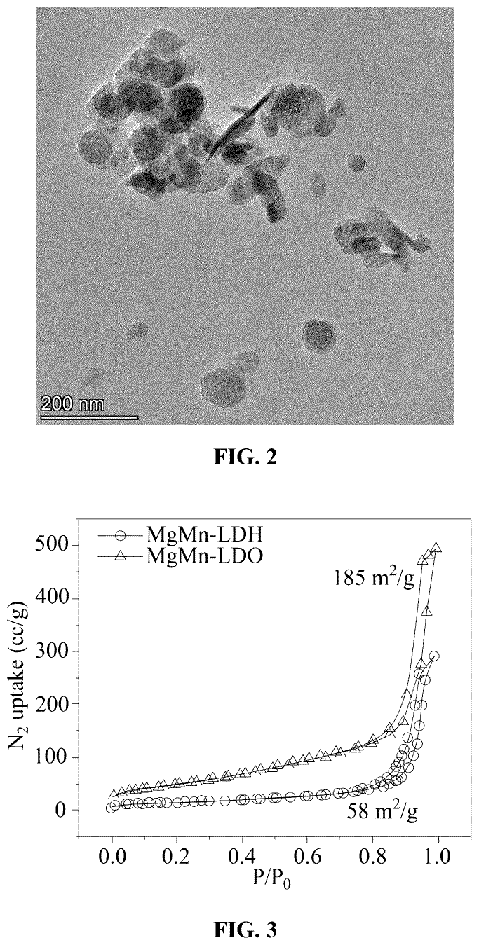

FIG. 2 shows a TEM image of the magnesium-manganese layered double oxide prepared in Example 1. It can be clearly seen that the morphology of the magnesium-manganese layered double oxide prepared in Example 1 is not significantly different from the irregular hexagonal nanosheet morphology of MgMn-LDH. However, unlike the smooth surface of the MgMn-LDH nanosheet, the magnesium-manganese layered double oxide nanosheet obtained in Example 1 is produced through the aggregation of a large number of nanoparticles, and presents a porous structure.

FIG. 3 shows a BET plot of the magnesium-manganese layered double oxide prepared in Example 1. It can be seen from FIG. 3 that the magnesium-manganese layered double oxide has a BET specific surface area of 185 m²/g, which is about three times the BET specific surface area of the magnesium-manganese layered double oxide precursor (MgMn-LDH).

### Example 2

2.42 g (0.06 mol) of nano-magnesium oxide (with a particle size of 50 nm) and 2.56 g (0.01 mol) of magnesium nitrate hexahydrate were weighed and added to a 316 L stainless-steel ball-mill jar filled with zirconia balls in a total mass of 20 g. Among the zirconia balls, a mass proportion of the zirconia balls with a diameter of 1 mm was 15%, a mass proportion of the zirconia balls with a diameter of 5 mm was 25%, and a mass proportion of the zirconia balls with a diameter of 10 mm was 60%. A resulting mixture was subjected to ball-milling at a rotational speed of 600 rpm for 5 h. Then, the ball-mill jar was opened, 2.51 g (0.01 mol) of manganese nitrate tetrahydrate was added to the opened ball-mill jar, 5 mL of absolute ethanol was added thereto and mixed evenly. An obtained mixture was subjected to ball-milling at a rotational speed of 700 rpm for 6 h, and then centrifugation to obtain a precipitate. The precipitate was subjected to washing three times with deionized water and ethanolin sequence, and then drying in a 60° C. oven for 12 h to obtain a magnesium-manganese layered double oxide precursor. A molar ratio of Mg²⁺ to Mn²⁺ in the magnesium-manganese layered double oxide precursor was 7:1. The magnesium-manganese layered double oxide precursor was placed in a muffle furnace, and heated to 350° C. at a heating rate of 5° C./min, calcined at 350° C. for 3 h, and then cooled naturally to obtain a magnesium-manganese layered double oxide (a molar ratio of manganese to magnesium in the magnesium-manganese layered double oxide was 1:7).

### Use Example 1

Adsorption of the magnesium-manganese layered double oxide prepared in Example 1 to arsenic:

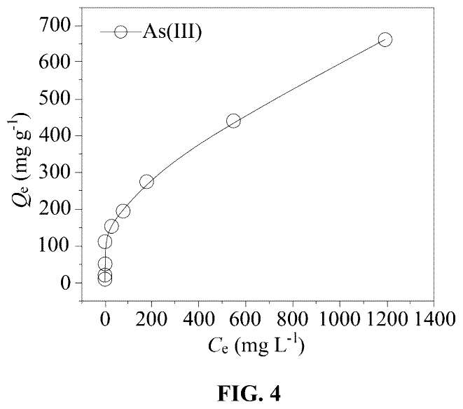

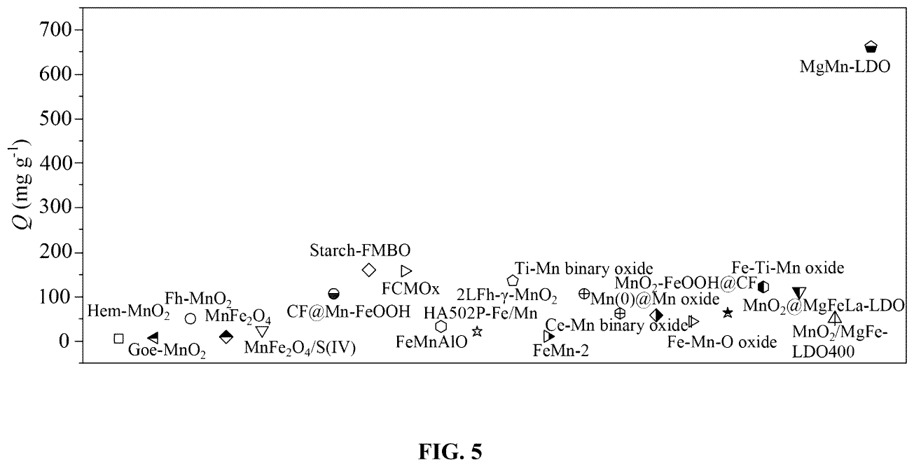

0.1 g of the magnesium-manganese layered double oxide obtained in Example 1 was added to a 200 mL beaker, and 100 mL of a sodium arsenite solution with an arsenic concentration of 10 mg/L to 2,000 mg/L was added thereto. A resulting system was subjected to magnetic stirring at room temperature for 12 h until an adsorption equilibrium was reached. A resulting supernatant was collected, filtered through a 0.22 μm filter membrane, and then tested for an As concentration by inductively coupled plasma optical emission spectrometry (ICP-OES). Adsorption capacities for arsenic at different concentrations are shown in FIG. 4. A maximum adsorption capacity calculated for the magnesium-manganese layered double oxide is 662.4 mg/g, which is significantly greater than adsorption capacities of other adsorbents currently reported (as shown in FIG. 5).

### Use Example 2

Adsorption of the magnesium-manganese layered double oxide prepared in Example 2 to arsenic-cadmium mixed heavy metals:

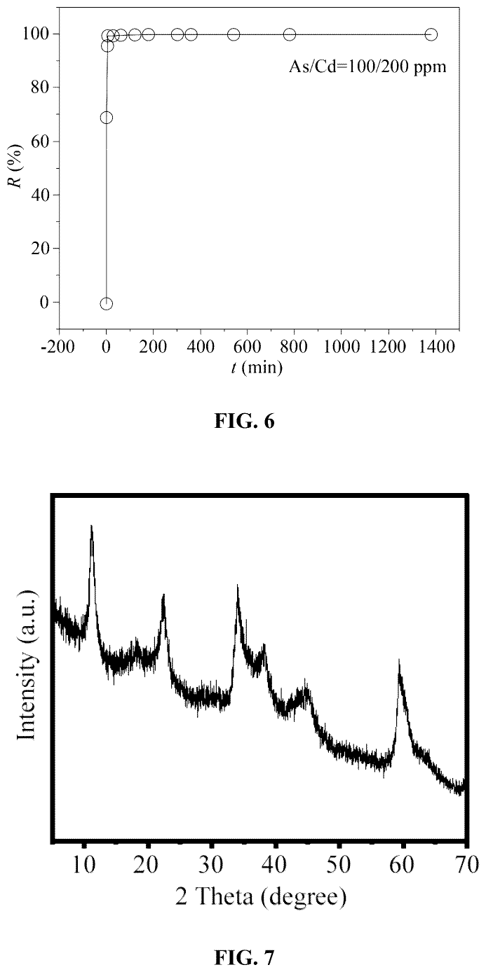

0.1 g of the magnesium-manganese layered double oxide obtained in Example 2 was added to a 200 mL beaker, and 100 mL of a sodium arsenite-cadmium nitrate mixed solution with an arsenic concentration of 100 mg/L and a cadmium concentration of 200 mg/L was added thereto. A resulting mixed solution was adjusted to a pH of about 5, and subjected to magnetically stirring at room temperature for 12 h until an adsorption equilibrium was reached. A resulting supernatant was collected, filtered through a 0.22 μm filter membrane, and then tested for As and Cd concentrations by ICP-OES. Removal rate results at different time intervals are shown in FIG. 6. It can be seen from FIG. 6 that, the magnesium-manganese layered double oxide in Example 2 could achieve an adsorption equilibrium for arsenic-cadmium mixed heavy metals within 10 min. The addition of Cd significantly increases an adsorption rate of the magnesium-manganese layered double oxide for arsenic, indicating that the magnesium-manganese layered double oxide has a strong affinity for arsenic-cadmium mixed heavy metals.

FIG. 7 shows an XRD pattern of the magnesium-manganese layered double oxide in Example 2 after adsorbing cadmium and arsenic. As shown in FIG. 7, after the adsorption of cadmium and arsenic, the XRD pattern of the magnesium-manganese layered double oxide presents typical characteristic diffraction peaks of hydrotalcite, indicating that the magnesium-manganese layered double oxide exhibits a significantly different adsorption mechanism for cadmium-arsenic combined pollution from the existing materials. Based on the analysis of the XRD pattern, during the adsorption process of cadmium-arsenic mixed pollutants, the magnesium-manganese layered double oxide undergoes a topological phase transition. That is, cadmium ions in a solution replace magnesium in the magnesium-manganese layered double oxide to produce magnesium-cadmium-manganese ternary hydrotalcite, which is consistent with the isomorphism in geology, and is unlike the adsorption of cadmium ions on the surface of the conventional material. Through this special adsorption mode, cadmium is fixed in lattices. Due to the abundant coordination bonds among lattices and the interaction between the host and guest, it is extremely difficult for cadmium ions to be desorbed. Moreover, a significant increase in the interlayer spacing could also be known in the XRD pattern, indicating that large-sized guest molecules have intercalated into the interlayer spaces. According to the anion types in the reaction system, the guest anions are arsenate or arsenite ions, indicating that the pollutant arsenic is confined within the limited interlayer spaces. The above results show that the magnesium-manganese layered double oxide achieves the simultaneous adsorption of cadmium and arsenic through different adsorption pathways when used for treating cadmium-arsenic combined pollution, and solves the problem that the existing materials can hardly achieve the effective synchronous adsorption of cadmium and arsenic.

It can be seen from Use Examples 1 to 2 that the magnesium-manganese layered double oxide exhibits outstanding performance in both treating the arsenic pollutant alone and simultaneously treating cadmium and arsenic pollutants. It further shows that the material according to the present disclosure simultaneously adsorb cadmium and arsenic pollutants through different adsorption mechanisms.

### Use Example 3

Remediation of an arsenic-cadmium mixed heavy metal-contaminated soil with the magnesium-manganese layered double oxide obtained in Example 2:

500 g of the cadmium-arsenic mixed heavy metal-contaminated soil and 10 g of the magnesium-manganese layered double oxide obtained in Example 2 were fully mixed in a beaker. 300 mL of deionized water was added thereto. An obtained mixture was subjected to stirring to obtain a paste. The paste was naturally placed until dried to obtain a soil sample. Vigna angularis seeds were sown in the soil sample. After seedling emergence, Vigna angularis seedlings further grow for 20 days, then was carefully uprooted, washed, air-dried, and weighed. Then, the contents of cadmium and arsenic in Vigna angularis seedlings were determined according to a method in a national standard. A cadmium content is 0.021 mg/kg and an arsenic content is 0.11 mg/kg, which do not exceed the limits for cadmium and arsenic contents in vegetables stipulated in a national standard (the cadmium content must not exceed 0.1 mg/kg and the arsenic content must not exceed 0.5 mg/kg).

### Comparative Example

In order to further illustrate the effect of the magnesium-manganese layered double oxide in the remediation of the cadmium-arsenic-contaminated soil, the verification in this comparative example was conducted. This comparative example was different from Use Example 3 merely in that the magnesium-manganese layered double oxide was not added to the contaminated soil.

500 g of the cadmium-arsenic mixed heavy metal-contaminated soil was taken and fully mixed in a beaker. 300 mL of deionized water was added thereto. A resulting mixture was subjected to stirring to obtain a paste. The paste was naturally placed until dried to produce a soil sample. Vigna angularis seeds were sown in the soil sample. After seedling emergence, Vigna angularis seedlings further grow for 20 days, then was carefully uprooted, washed, air-dried, and weighed. Then, the contents of cadmium and arsenic in Vigna angularis seedlings were determined according to the method in the national standard. A cadmium content is 0.283 mg/kg and an arsenic content is 0.741 mg/kg, which exceed the limits stipulated in the national standard. Thus, these vegetables do not meet the national requirements, and are highly likely to pose a threat to human health after being eaten.

The comparison of Use Example 3 with the comparative example demonstrates that the magnesium-manganese layered double oxide according to the present disclosure plays a very significant role in the remediation of the cadmium-arsenic contaminated soil.

Although the present disclosure is described in detail through the above embodiments, the above embodiments are merely some rather than all of the embodiments of the present disclosure. Other embodiments can be acquired based on the above embodiments without creative efforts, and all of these examples shall fall within the scope of the present disclosure.

What is claimed is:

1. A method for preparing a layered double oxide, comprising the following steps:
mixing magnesium oxide and a hydrate of a magnesium salt, and subjecting a resulting mixture to ball-milling to obtain a ball-milled material;
mixing the ball-milled material and a hydrate of a manganese salt, and subjecting an obtained mixture to wet-milling to obtain a layered double oxide precursor; and
subjecting the layered double oxide precursor to calcining to obtain the layered double oxide,
wherein a molar ratio of magnesium in the magnesium oxide to magnesium in the magnesium salt is in a range of 1:1 to 6:1.

2. The method of claim 1, wherein the magnesium salt comprises at least one selected from the group consisting of magnesium chloride, magnesium sulfate, magnesium carbonate, and magnesium nitrate.

3. The method of claim 1, wherein the manganese salt comprises at least one selected from the group consisting of manganese chloride, manganese nitrate, manganese sulfate, and manganese carbonate.

4. The method of claim 1, wherein a molar ratio of manganese in the manganese salt to magnesium in the ball-milled material is in a range of 1:10 to 1:5.

5. The method of claim 1, wherein a ball-to-material ratio in the ball-milling and a ball-to-material ratio in the wet-milling are each independently 5:1 to 20:1; a rotational speed of the ball-milling and a rotational speed of the wet-milling are each independently 400 revolutions per minute (rpm) to 800 rpm; milling balls adopted in the ball-milling and the wet-milling are made of zirconia; and the milling balls have a diameter independently of 1 millimeter (mm) to 10 mm.

6. The method of claim 1, wherein the calcining is conducted at a temperature of 300° C. to 500° C. for 2 hours (h) to 6 h.

7. The method of claim 6, wherein a heating rate of raising to the temperature for the calcining is in a range of 3° C./minutes (min) to 10° C./min.

8. A layered double oxide prepared by the method of claim 1, wherein the layered double oxide is a magnesium-manganese layered double oxide, and a molar ratio of manganese to magnesium in the magnesium-manganese layered double oxide is in a range of 1:10 to 1:5.

9. The layered double oxide of claim 8, wherein the layered double oxide has a Brunauer-Emmett-Teller (BET) specific surface area of 50 m²/g to 200 m²/g.

10. The method of claim 2, wherein the ball-to-material ratio in the ball-milling and the ball-to-material ratio in the wet-milling are each independently 5:1 to 20:1; the rotational speed of the ball-milling and the rotational speed of the wet-milling are each independently 400 rpm to 800 rpm; milling balls adopted in the ball-milling and the wet-milling are made of zirconia; and the milling balls have the diameter independently of 1 mm to 10 mm.

11. The method of claim 3, wherein the ball-to-material ratio in the ball-milling and the ball-to-material ratio in the wet-milling are each independently 5:1 to 20:1; the rotational speed of the ball-milling and the rotational speed of the wet-milling are each independently 400 rpm to 800 rpm; milling balls adopted in the ball-milling and the wet-milling are made of zirconia; and the milling balls have the diameter independently of 1 mm to 10 mm.

12. The method of claim 4, wherein the ball-to-material ratio in the ball-milling and the ball-to-material ratio in the wet-milling are each independently 5:1 to 20:1; the rotational speed of the ball-milling and the rotational speed of the wet-milling are each independently 400 rpm to 800 rpm; milling balls adopted in the ball-milling and the wet-milling are made of zirconia; and the milling balls have the diameter independently of 1 mm to 10 mm.

13. The layered double oxide of claim 8, wherein the magnesium salt comprises at least one selected from the group consisting of magnesium chloride, magnesium sulfate, magnesium carbonate, and magnesium nitrate.

14. The layered double oxide of claim 8, wherein the manganese salt comprises at least one selected from the group consisting of manganese chloride, manganese nitrate, manganese sulfate, and manganese carbonate.

15. The layered double oxide of claim 8, wherein the molar ratio of manganese in the manganese salt to magnesium in the ball-milled material is in a range of 1:10 to 1:5.

16. The layered double oxide of claim 8, wherein the ball-to-material ratio in the ball-milling and the ball-to-material ratio in the wet-milling are each independently 5:1 to 20:1; the rotational speed of the ball-milling and the rotational speed of the wet-milling are each independently 400 rpm to 800 rpm; milling balls adopted in the ball-milling and the wet-milling are made of zirconia; and the milling balls have the diameter independently of 1 mm to 10 mm.

17. The layered double oxide of claim 8, wherein the calcining is conducted at a temperature of 300° C. to 500° C. for 2 hours (h) to 6 h.

18. The layered double oxide of claim 8, wherein the heating rate of raising to the temperature for the calcining is in a range of 3° C./minutes (min) to 10° C./min.
